(19) United States
(12) Patent Application Publication
(10) Pub. No.: US 2018/0096616 A1
(43) Pub. Date: Apr. 5, 2018

(54) VISUAL LEARNING AND THERAPY DEVICE

(71) Applicant: Charles Robert Iversen, Lakewood, CO (US)

(72) Inventor: Charles Robert Iversen, Lakewood, CO (US)

(21) Appl. No.: 15/723,613

(22) Filed: Oct. 3, 2017

Related U.S. Application Data
(60) Provisional application No. 62/403,520, filed on Oct. 3, 2016.

(51) Int. Cl. G09B 5/06

(52) U.S. Cl. CPC G09B 5/062

(57) ABSTRACT

A visual learning and therapy device that includes a foam core and a fabric layer disposed outwardly and surrounding the core. Images and/or words may be incorporated into the fabric through printing or other process. In one embodiment, various textures and other learning tools to be incorporated into or fastened to the fabric layer. The foam may include one or more audio or visual stimulation devices inserted therein. The visual learning and therapy device of the present invention may further comprise a water-proof or water-resistant membrane surrounding the foam core. The water-proof or water-resistant membrane may be positioned between the foam core and the fabric layer. In one embodiment, the visual learning and therapy device may include a foam core in the shape of a cube; however, other geometric shapes are within the scope of the present invention.

### CROSS-REFERENCE TO RELATED APPLICATIONS

This Application claims priority to U.S. Provisional Patent Application No. 62/403,520, filed Oct. 3, 2016, entitled “Visual Learning and Therapy Cube” to Chuck (Charles) Robert Iversen, currently pending, the entire disclosure of which is incorporated herein by reference.

### BACKGROUND

Learning has a significant visual component. Images and pictures are often used in early childhood development as well as therapy for brain injuries in older children and adults. There are a few existing products which comprise a cube having clear sleeve or cover in which a printed picture can be inserted. While this may seem to protect the photo, it doesn't prevent the intended user (infants/children) from removing the photos themselves, and does little to protect the printed photos from being damaged if the cube can be compressed and contorted in many ways thereby creasing and crinkling the printed picture. Moreover, the inclusion of a clear plastic or PVC surface is not a tactile product for infants and children to play with and feel.

Thus, there is a need in the art for a visual learning and therapy device which allows a user to compress, squeeze, or otherwise manipulate a soft device without damaging the image on the side of the device. Further, there is a need in the art to provide a soft surface in such visual learning and therapy devices that provide some touch stimulation for the users.

### SUMMARY OF THE INVENTION

A visual learning and therapy device that includes a foam core and a fabric layer disposed outwardly and surrounding the core. One of the improvements of this visual learning and therapy device is that the images may be incorporated into the fabric through printing or other process. This also allows for the introduction of various textures and other learning tools to be incorporated into or fastened to the fabric layer. The fabric layer may have one or more images printed thereon. The foam core of the visual learning and therapy device may also include one or more audio or visual stimulation devices inserted therein. In one embodiment, the audio or visual stimulation device may be positioned near a center of the foam core and may include a battery supply.

The visual learning and therapy device of the present invention may further comprise a water-proof or water-resistant membrane surrounding the foam core. The water-proof or water-resistant membrane may be positioned between the foam core and the fabric layer. The water-proof or water-resistant membrane may also be of a material that generates noise when manipulated.

In one embodiment, the visual learning and therapy device may include a foam core in the shape of a cube, the foam core having six side surfaces; a water-proof or water-resistant membrane surrounding the foam core and forming a cubic cover to cover each of the six side surfaces; and a fabric cover disposed outwardly and surrounding the membrane, wherein the fabric cover includes six panels, which correspond to the six side surfaces of the core, and each panel may have one or more images printed on each side surface. However, geometric shapes other than a cube are within the scope of the present invention.

Other aspects and advantages of the present invention will be apparent from the following detailed description of the preferred embodiments and the accompanying drawing figures.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views, and wherein:

FIG. 1 is a schematic top perspective view of one embodiment of a visual learning and therapy device in accordance with the teachings of the present invention; and

FIG. 2 is a schematic section view of the embodiment of the visual learning and therapy device of FIG. 1 cut along the line 2-2.

### DETAILED DESCRIPTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the spirit and scope of the present invention. The present invention is defined by the appended claims and, therefore, the description is not to be taken in a limiting sense and shall not limit the scope of equivalents to which such claims are entitled.

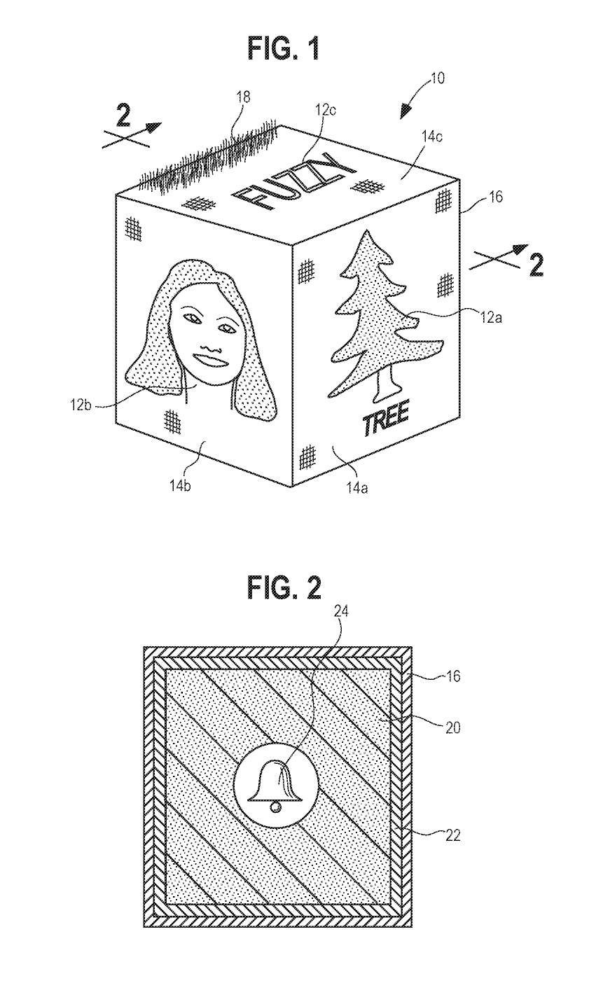

The present invention is directed toward a visual learning and therapy device 10. As shown in FIG. 1, visual learning and therapy device 10 may be a cube that includes one or more images 12a, 12b, and 12c printed or imprinted on a surface 14a, 14b, and 14c of a fabric cover 16. Images 12a, 12b, or 12c may be permanently printed or otherwise placed directly on fabric cover 16. Fabric cover 16 may be sewn or adhered over a foam core (see FIG. 2). Images 12a, 12b, 12c may be a photograph, a picture of an object, or a word in any language, or any other visual stimulant desired that is directly printed or transferred onto the fabric. In addition, a surface 14 of the fabric cover 16 of device 10, such as 14a as shown may also include any known tactile stimulation element 18 using decorative trim or framing on one or more surface 14. A person of skill in the art would appreciate that a cube has six sides and six side surfaces, any or all of which may include images, words, and/or other stimuli. The present visual learning and therapy device 10 may also be other shapes, including a cylinder, sphere, or other solid extended members having a polygon cross-section, such as an extended pyramid, pentagon, hexagon, octagon, etc.

Fabric cover 16 may be of any material known in the art, including cotton-based fabrics, nylon, polymer based fabrics, pvc, plastic, burlap, canvas, or any other material.

As shown in FIG. 2, which is a cross-section of the cube of FIG. 1, the construction of one embodiment of the present visual learning and therapy device 10 is illustrated. In the embodiment shown, a foam core 20 is surrounded by a membrane 22 that is water-proof or water-resistant, and fabric cover 16 surrounds membrane 22. Membrane 22 may be polyolefin, shrink wrap, Gore-Tex or other water-proof membrane which may or may not be breathable. Other embodiments may or may not include the membrane 22.

Foam core 20 may be any foam known in the art and applicable for the intended purpose. Such foams may include, but are not limited to, latex, polyurethane, polyethylene, high-density, memory, soy-based, polystyrene, closed cell, open cell, or any material that is foam-like. Preferably, the foam allows a user to squeeze or manipulate the device 10, but foams of various densities will be applicable in for different uses, particularly in therapeutic applications.

As further shown in FIG. 2, optional audible or visual stimulation devices 24 placed within the foam core 20. Such devices may include bells, squeak-toys, lights, or speakers, blue-tooth or other wireless speakers, or any other audio or visual stimulation device and any power source necessary to power such devices. In one embodiment, the audio or visual stimulation device corresponds to the image on the fabric cover 16.

By permanently placing the photographic image directly on, or within, the fabric itself using modern digital printing processes, one can squeeze, compress, flex, and play with the soft, foam device without fear of damaging the photographic image or the product. Being able to squeeze and smash the product over and over without destroying the photograph potentially gives the product a longer usage life and/or a more distinguished use in a variety of medical and educational fields, among others, as a means of physical therapy and/or brain development. Placing the photographic image directly on the fabric itself also allows for the other tactile stimuli to be adhered directly to the fabric, creating a more durable product.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

I claim:

1. A visual learning and therapy device comprising:
a foam core; and
a fabric layer disposed outwardly and surrounding said foam core, wherein said fabric layer has one or more images printed thereon.

2. The visual learning and therapy device of claim 1 wherein said foam core includes one or more audio or visual stimulation devices.

3. The visual learning and therapy device of claim 2 wherein said one or more audio or visual stimulation devices is disposed at an embedded location in said foam core.

4. The visual learning and therapy device of claim 2 wherein said one or more audio or visual stimulation devices is one of a bell, a squeak-toy, a light, a speaker, a blue-tooth speaker, or a wireless speaker.

5. The visual learning and therapy device of claim 2, wherein the audio or visual stimulation device corresponds to an image on the fabric cover.

6. The visual learning and therapy device of claim 1 further comprising a water-proof or water-resistant membrane surrounding the foam core, wherein said water-proof or water-resistant membrane is disposed between said foam core and said fabric layer.

7. The visual learning and therapy device of claim 1 further comprising a tactile stimulation element.

8. A visual learning and therapy device comprising:
a foam core in the shape of a cube, said foam core having six side surfaces;
a water-proof or water-resistant membrane surrounding the foam core and forming a cubic cover to cover each of said six side surfaces; and
a fabric cover disposed outwardly and surrounding said membrane, wherein said fabric cover includes six panels, each of said panel corresponding to one of said six side surfaces, and a plurality of said six panels having one or more images printed thereon.

9. The visual learning and therapy device of claim 8 further comprising a tactile stimulation element.

10. The visual learning and therapy device of claim 8 wherein said foam core includes one or more audio or visual stimulation devices.

11. The visual learning and therapy device of claim 8 wherein said one or more audio or visual stimulation devices is disposed at an embedded location in said foam core.

12. The visual learning and therapy device of claim 10 wherein said one or more audio or visual stimulation devices is one of a bell, squeak-toys, lights, speakers, blue-tooth or other wireless speakers, or any other audio or visual stimulation device.

13. The visual learning and therapy device of claim 10, wherein the audio or visual stimulation device is configured to correspond to at least one of said one or more images printed on at least one of the plurality of said six panels.

14. A visual learning and therapy device comprising:
a foam core in the shape of a cube, said foam core having six side surfaces;
a water-proof or water-resistant membrane surrounding the foam core and forming a cubic cover to cover each of said six side surfaces; and
a fabric cover disposed outwardly and surrounding said membrane, wherein said fabric cover includes six panels each of said panel corresponding to one of said six side surfaces, and a plurality of said six panels having one or more images printed thereon;
a tactile stimulation element disposed on at least one of said six side surfaces; and
one or more audio or visual stimulation devices.

15. The visual learning and therapy device of claim 14 wherein the audio or visual stimulation device is configured to correspond to at least one of said one or more images printed on at least one of the plurality of said six panels.

16. The visual learning and therapy device of claim 14 wherein said one or more audio or visual stimulation devices comprises one of blue-tooth or wireless speakers.
